(19) United States
(12) Patent Application Publication
(10) Pub. No.: US 2014/0163862 A1
(43) Pub. Date: Jun. 12, 2014

(54) APPARATUS AND METHOD FOR CONTROLLING PARKING ASSISTANCE

(71) Applicant: HYUNDAI MOTOR COMPANY, Seoul (KR)

(72) Inventors: Jae Seob Choi, Gyeonggi-do (KR); Dae Joong Yoon, Gyeonggi-do (KR); Eu Gene Chang, Gyeonggi-do (KR)

(73) Assignee: Hyundai Motor Company, Seoul (KR)

(21) Appl. No.: 13/801,293

(22) Filed: Mar. 13, 2013

(30) Foreign Application Priority Data
Dec. 11, 2012 (KR) 10-2012-0143923

(51) Int. Cl. G01C 21/26

(52) U.S. Cl. CPC G01C 21/26
USPC 701/400

(57) ABSTRACT

An apparatus for providing parking assistance includes: a parking space searching unit that searches parking spaces around a vehicle by analyzing images and sensor-measuring values inputted from a camera and a sensor in the vehicle; a parking path range calculating unit that calculates a range available for generating parking paths for a target parking space selected from the searched parking spaces; a parking type determining unit that determines types of available parking in the calculated available range for generating parking paths and provides parking path ranges on the basis of parking paths estimated from the types of parking; and a parking assistance processing unit that provides parking assistance information for the vehicle in accordance with a target parking path range selected from the parking type-differentiated parking path ranges.

### CROSS-REFERENCE TO RELATED APPLICATION

This application claims benefit of priority to Korean Patent Application No. 10-2012-0143923, filed on Dec. 11, 2012 in the Korean Intellectual Property Office, the disclosure of which is incorporated herein in its entirety by reference.

### TECHNICAL FIELD

The present disclosure relates to an apparatus and a method for providing parking assistance, and more particularly, to a technology of providing the range of parking paths for available types of parking within available ranges for generating parking paths for a target parking area in parking.

### BACKGROUND

Recently, vehicles are equipped with a parking assistance system such as an SPAS (Smart Parking Assist System), which provides drivers with a parking assistance service in parking their vehicles.

The SPASs determine a target position to park, set a path for parking to the target position, and provide a driver with information on the set path on the basis of the image data of the area surrounding a vehicle.

However, because the existing SPASs provide drivers with the information on straight or curved parking paths, the vehicles may collide with other vehicles around the parking space, when the centers of the vehicles are not on the parking paths even if the drivers park along the parking paths.

### SUMMARY OF THE INVENTION

Accordingly, the present invention has been made to solve the above-mentioned problems occurring in the prior art while maintaining advantages achieved by the prior art intact

A need exists for providing an apparatus and a method for controlling parking assistance which provide information on available ranges to generate parking paths for a target parking area and the range of parking paths for available types of parking within the available range for generating parking paths, in parking.

Another need exists for providing an apparatus and a method for controlling parking assistance which can alleviate drivers' anxiety about colliding with vehicles around the parking space, by calculating parking paths in accordance with the length, widths, turning angles, and the like of the vehicle.

Still another need exists for providing an apparatus and a method for controlling parking assistance which provide information on a stop time point and a shifting time point in real time through an image in parking assistance.

One aspect of the present disclosure provides an apparatus for controlling parking assistance including: a parking space searching unit that searches parking spaces around a vehicle by analyzing images and sensor-measuring values inputted from a camera and a sensor in the vehicle; a parking path range calculating unit that calculates available range for generating parking paths for a target parking space selected from the searched parking spaces; a parking type determining unit that determines available parking types in the calculated available range for generating parking paths and provides parking path ranges on the basis of parking paths estimated from parking types; and a parking assistance processing unit that provides parking assistance information for the vehicle in accordance with a target parking path range selected from the parking type-differentiated parking path ranges.

The parking path range calculating unit may recognize parking lines around the vehicle and calculate available ranges for generating parking paths on the basis of the recognized parking lines.

When there is no parking line recognized around the vehicle, the parking path range calculating unit may calculate available ranges for generating parking paths on the basis of the sensor-measuring values.

The parking assistance processing unit may provide information on stop and shifting time points of the vehicle within the target parking path range.

The input images may be AVM (Around View Monitoring) images.

Another aspect of the present disclosure provides a method of controlling parking assistance including: searching parking spaces around a vehicle by analyzing images and sensor-measuring values inputted from a camera and a sensor in the vehicle; calculating available range for generating parking paths for a target parking space selected from the searched parking spaces; determining available parking types in the calculated available range for generating parking paths and providing parking path ranges on the basis of parking paths estimated from parking types; and providing parking assistance information for the vehicle in accordance with a target parking path range selected from the parking type-differentiated parking path ranges.

### BRIEF DESCRIPTION OF THE DRAWINGS

The above and other objects, features and advantages of the present disclosure will be more apparent from the following detailed description taken in conjunction with the accompanying drawings, in which:

FIG. 1 is a block diagram illustrating the configuration of an apparatus for controlling parking assistance according to an exemplary embodiment of the present disclosure;

FIGS. 2(a)-2(f) illustrate examples of controlling operation of an apparatus for controlling parking assistance according to an exemplary embodiment of the present disclosure;

FIGS. 3A to 3D illustrate examples of calculating ranges available for generating parking paths of FIG. 2;

FIGS. 4(a)-4(e) illustrate examples of providing of parking assistance information of FIG. 2; and

FIG. 5 is a flowchart illustrating a method of providing parking assistance according to an exemplary embodiment of the present disclosure.

### DETAILED DESCRIPTION

Hereinafter, exemplary embodiments of the present disclosure will be described with reference to the accompanying drawings

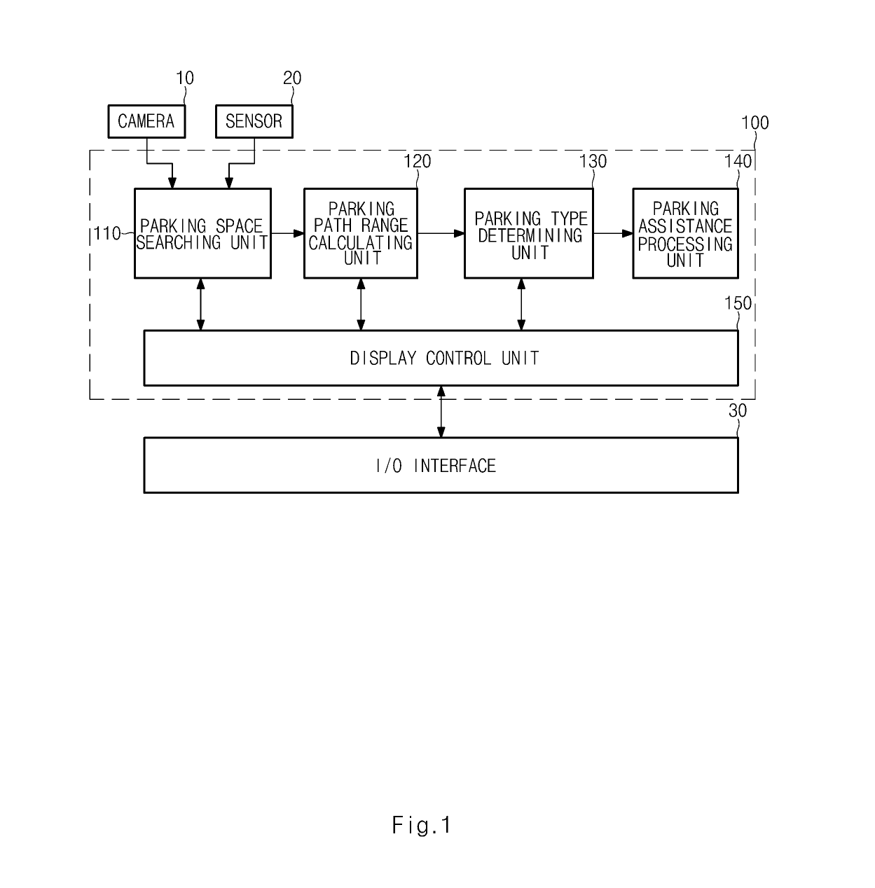

FIG. 1 is a block diagram illustrating the configuration of an apparatus for providing parking assistance according to an exemplary embodiment of the present disclosure. Referring to FIG. 1, an apparatus 100 for controlling parking assistance according to the exemplary embodiment includes a parking space searching unit 110, a parking path range calculating unit 120, a parking type determining unit 130, a parking assistance processing unit 140, and a display control unit 150.

First, the parking space searching unit 110 receives surrounding images of a vehicle from a camera 10 in the vehicle. The parking space searching unit 110 described herein may receive AVM (Around View Monitoring) images from an AVM system. It is assumed in the following description that the input image is an AVM image. However, the input image is not limited to the AVM image. Further, the parking space searching unit 110 receives a sensor-measuring value from a sensor 20 in a vehicle. The sensor 20 described herein may be an ultrasonic sensor for measuring a distance, but is not limited thereto.

The parking space searching unit 110 searches parking spaces around a vehicle by analyzing the AVM images and the sensor-measuring value. The parking space searching unit 110 transmits the parking space search result to the parking path range calculating unit 120 and the display control unit 150. The display control unit 150 outputs the parking space search result inputted from the parking space searching unit 110 to an I/O interface 30 such as a touch screen such that the parking spaces are displayed in an image on the I/O interface 30. In detail, the searched parking spaces are displayed in the AVM image on the I/O interface 30.

Therefore, a user can check the parking spaces around a vehicle from the image on the I/O interface 30, and can select a target parking space from the parking spaces displayed in an image on the I/O interface 30.

The display control unit 150 outputs a control signal to the parking path range calculating unit 120, when the information on the selection of the target parking space is inputted through the I/O interface 30.

When a control signal is inputted from the display control unit 150, the parking path range calculating unit 120 calculates ranges within which a parking path to the target parking space can be generated from the parking space search information inputted by the parking space searching unit 110. When a user selects a target parking space, the parking path range calculating unit 120 may receive only the information on the target parking space from the parking space search unit 110.

The parking path range calculating unit 120 can provide the entire range when parking paths can be generated for the target parking space in the AVM image.

The parking path range calculating unit 120 can recognize parking lines around the vehicle in the AVM image, and calculate available ranges within which parking paths can be generated with respect to the recognized parking lines. When there are other vehicles around the vehicle, the parking path range calculating unit 120 can calculate available ranges for generating parking paths in consideration of all of the recognized parking lines and the sensor-measuring value.

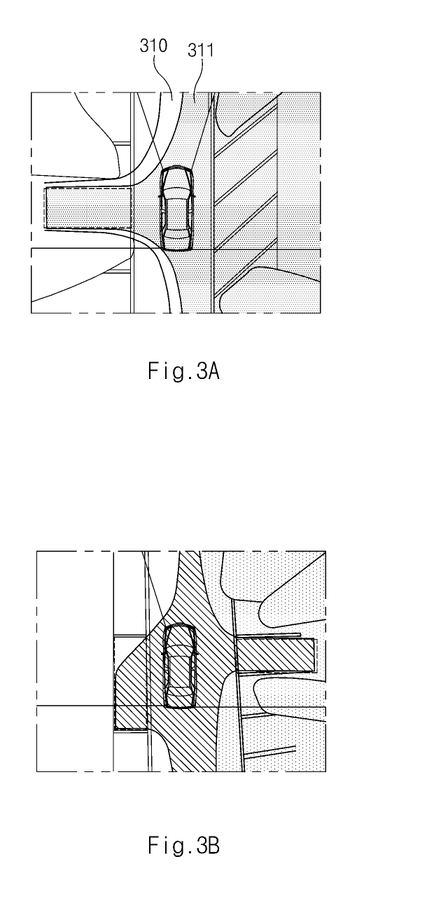

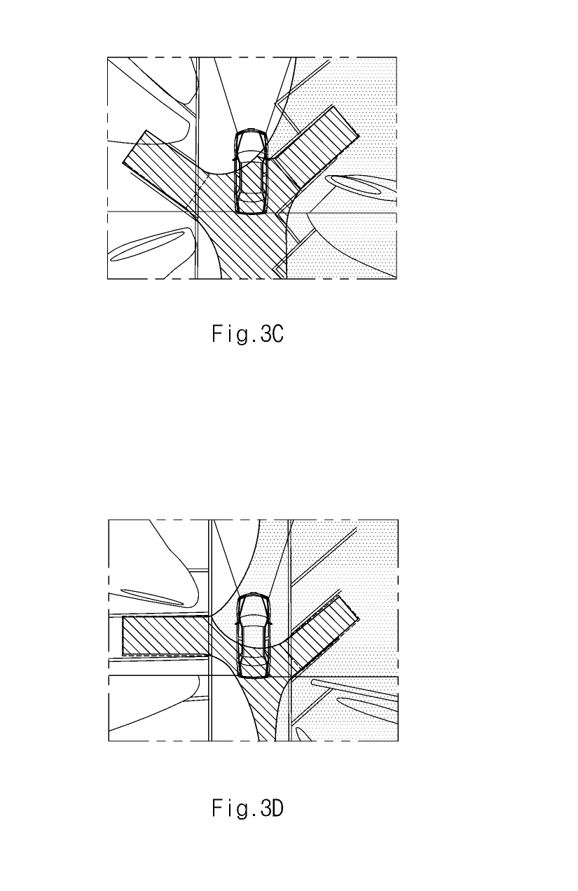

When there are no parking lines recognized around the vehicle in the AVM image, the parking path range calculating unit 120 can calculate available ranges for generating parking paths on the basis of the sensor-measuring value. The operation of calculating available ranges for generating parking paths by the parking path range calculating unit 120 will be described in more detail with respect to FIGS. 3A to 3D.

The parking path range calculating unit 120 transmits the result of calculating available ranges for generating parking paths to the display control unit 150 such that the result is displayed in an image on the I/O interface 30.

Further, the parking path range calculating unit 120 transmits the information on the calculated available range for generating parking paths to the parking type determining unit 130. The parking type determining unit 130 determines types of available parking in the available range for generating parking paths on the basis of the available range for generating parking paths inputted from the parking path range calculating unit 120. For example, the parking type determining unit 130 determines the types of available parking in the available range for generating parking paths from the current position of the vehicle such as head-in parking, back-in parking, parallel parking, and diagonal parking.

Further, the parking type determining unit 130 estimates a parking path for each available type of parking in the available range for generating parking paths and calculates the parking path ranges on the basis of the estimated parking paths. The parking type determining unit 130 can calculate the parking path ranges considering the length, width, and turning angle of the vehicle.

The parking type determining unit 130 transmits the information on the parking type-differentiated parking path ranges to the parking assistance processing unit 140. Further, the parking type determining unit 130 transmits the information on the parking type-differentiated parking path ranges to the display control unit 150 such that the information is displayed in an image on the I/O interface 30.

Therefore, the user can check the parking type-differentiated parking path ranges from the image on the I/O interface 30 and select the parking path range for a desired parking type from the parking type-differentiated parking path ranges displayed in an image on the I/O interface 30. The display control unit 150 outputs a control signal to the parking assistance processing unit 140, when the information about selection of the target parking path range is inputted through the I/O interface 30.

When a control signal is inputted from the display control unit 150, the parking assistance processing unit 140 outputs the parking assistance information for the current position of the vehicle on the basis of the parking path range for the parking type, which is selected from the parking type-differentiated parking path ranges inputted from the parking type determining unit 130. In this case, the display control unit 150 makes the parking assistance information inputted from the parking assistance processing unit 140 be displayed in an image on the I/O interface 30.

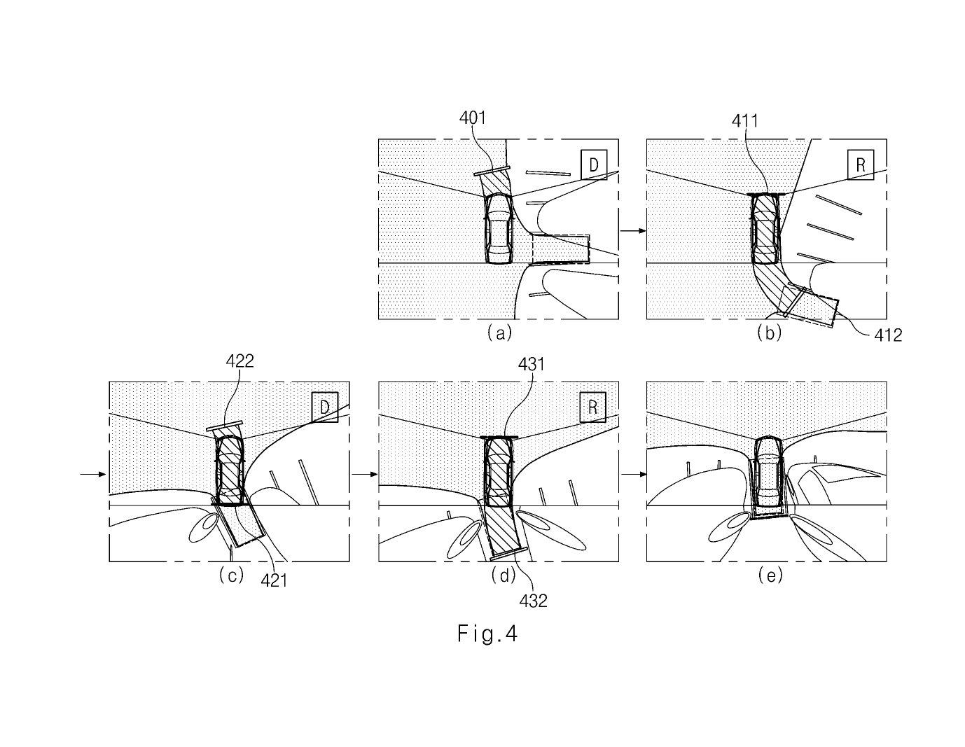

The parking assistance processing unit 140 can output information on guiding the vehicle to change the position into the target parking path range and can output information on stop and shifting time points. The operation of providing parking assistance information by the parking assistance processing unit 140 will be described in more detail with reference to FIGS. 4(a)-4(e).

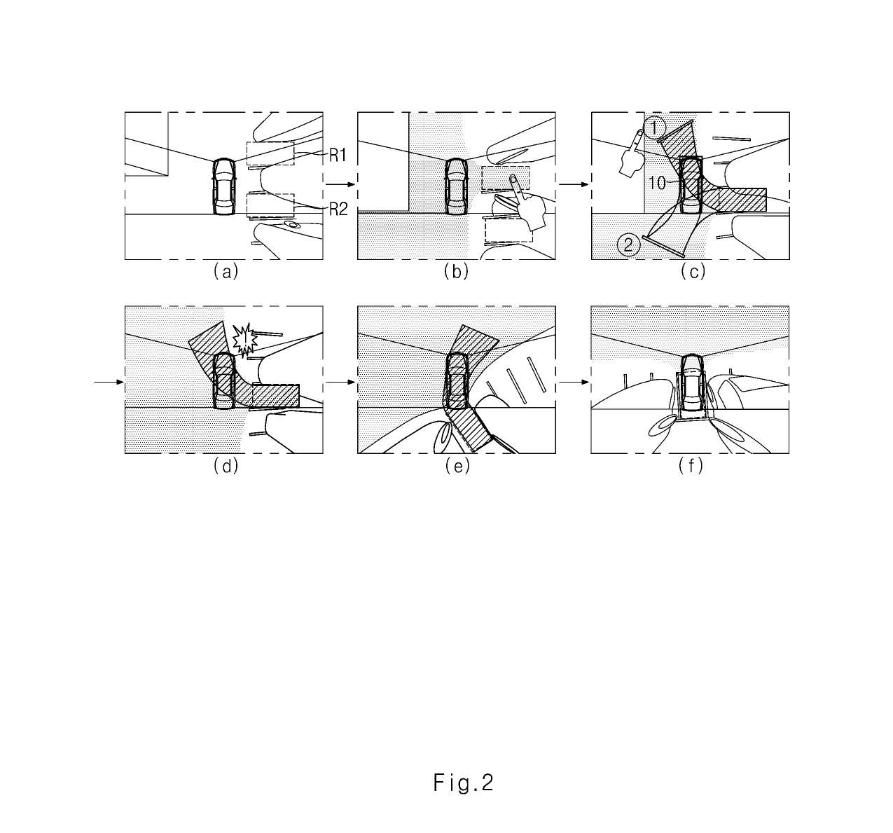

FIGS. 2(a)-2(f) are exemplary views to illustrate controlling parking assistance according to an exemplary embodiment of the present disclosure. In particular, FIGS. 2(a)-2(f) show images on an I/O interface which are produced in accordance with the operations of the apparatus for controlling parking assistance.

An apparatus for controlling parking assistance according to an exemplary embodiment of the present disclosure searches parking spaces around a vehicle first and uses AVM images and sensor-measuring values in the searching When parking spaces are searched, the apparatus for controlling parking assistance makes the searched parking spaces R1 and R2 be displayed with respect to the position of a vehicle 10 in an image, as shown in FIG. 2(a).

A user can select a target parking space, and when a target parking space is selected, as shown in FIG. 2(b), the apparatus for controlling parking assistance calculates available ranges for generating parking paths for the selected target parking space and makes the ranges be displayed in an image on the I/O interface.

Thereafter, the apparatus for controlling parking assistance calculates parking path ranges for the types of available parking in the available ranges for generating parking paths and makes parking type-differentiated parking path ranges \textcircled{1} and \textcircled{2} be displayed in an image on the I/O interface, as shown in FIG. 2(c). The user can select a parking path range between the ranges \textcircled{1} and \textcircled{2} for any one of parking types.

When the parking path range \textcircled{2} is selected, the apparatus for controlling parking assistance can make parking assistance information changing in accordance with position changes of the vehicle be displayed in an image on the I/O interface, as shown in FIGS. 2(d) to 2(f), and can alarm or make a steering wheel be automatically controlled, when the vehicle comes out of the parking path range \textcircled{1}.

FIGS. 3A to 3D are exemplary views illustrating the calculation of a range when parking paths of FIGS. 2(a)-2(f) can be generated.

First, FIG. 3A shows an example of setting an available range for generating a parking path, in which a reference range 310 calculated from sensor-measuring values and a parking section reference range 311 are shown. The apparatus for controlling parking assistance can set the reference range varying depending upon whether there are parking lines or whether there are other vehicles around.

FIG. 3B shows an available range for generating a parking path, when a perpendicular parking space and a parallel parking space with respect to the traveling direction of a vehicle are searched. The apparatus for controlling parking assistance calculates an available range for generating a parking path for the perpendicular parking space and an available range for generating a parking path for the parallel parking space.

FIG. 3C shows an available range for generating a parking path, when left and right diagonal parking spaces with respect to the traveling direction of a vehicle are searched. The apparatus for controlling parking assistance calculates an available range for generating a parking path for the left diagonal parking space and an available range for generating a parking path for the right diagonal parking space.

FIG. 3D shows an available range for generating a parking path, when a perpendicular parking space and a right diagonal parking space with respect to the traveling direction of a vehicle are searched. The apparatus for controlling parking assistance calculates an available range for generating a parking path for the perpendicular parking space and an available range for generating a parking path for the right diagonal parking space.

As described above, when parking spaces are searched around a vehicle from an AVM image, the apparatus for controlling parking assistance calculates available ranges for generating parking paths for the searched parking spaces. When a user selects a target parking space from the image, the apparatus can make the available ranges for generating parking path for the selected target parking space be displayed in the image of the I/O interface.

FIGS. 4(a)-4(e) are exemplary views to illustrate providing of parking assistance information of FIG. 2. Referring to FIGS. 4(a)-4(e), the apparatus for controlling parking assistance according to an exemplary embodiment of the present disclosure provides automatic parking assistance information corresponding to the parking type of parking path range selected from FIG. 2(c).

The apparatus for controlling parking assistance makes information on a drive mode D and a traveling path range to a stop line 401 be displayed in an image on the I/O interface, as illustrated in FIG. 4(a), in order to change the position of the vehicle for parking assistance by comparing the target parking space with the position of the vehicle.

When the vehicle travels forward and reaches a stop line 401, the apparatus for controlling parking assistance, as illustrated in FIG. 4(b), makes a stop time point indicating line 411 be displayed and makes information on a backward-traveling mode R and the traveling path range to the stop line 412 be displayed in the image on the I/O interface.

Referring to FIG. 4(c), when the vehicle travels backward and reaches a stop line 422, the apparatus for controlling parking assistance makes a stop time point indicating line 421 be displayed and makes information on the drive mode D and the traveling path range to the stop line 422 be displayed on the I/O interface.

Referring to FIG. 4(d), when the vehicle travels forward and reaches the stop line 422, the apparatus for controlling parking assistance makes a stop time point indicating line 431 be displayed and makes information on the backward-traveling mode R and the traveling path range to the stop line 432 be displayed in the image on the I/O interface.

Referring to FIG. 4(e), when the vehicle travels backward and reaches the stop line 432, the vehicle has reached the target parking space, so that the apparatus for controlling parking assistance finishes the parking assistance service.

The operation flow in the apparatus for controlling parking assistance having the configuration described above, according to an embodiment of the present disclosure, is described hereafter in more detail.

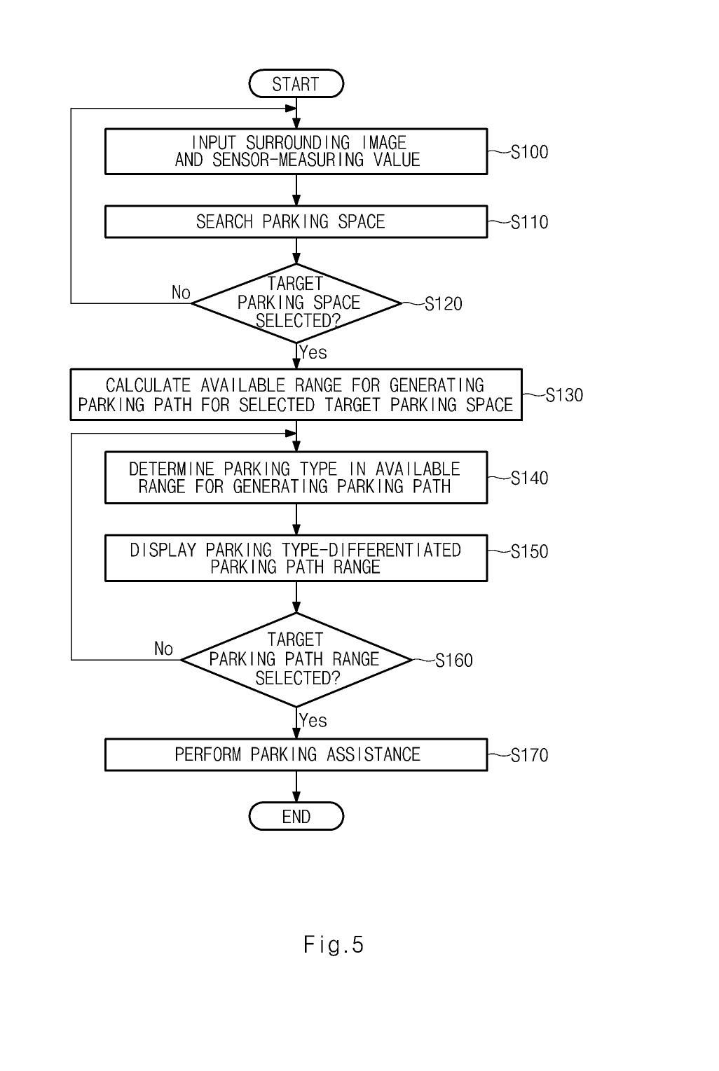

FIG. 5 is a flowchart illustrating the operational flow of a method of controlling parking assistance according to an exemplary embodiment of the present disclosure.

Referring to FIG. 5, when surrounding images and sensor-measuring values are inputted from a camera and a sensor in a vehicle (S100), an apparatus for controlling parking assistance according to an exemplary embodiment of the present disclosure searches the parking spaces input in S100 (S110).

The parking spaces searched in S110 are displayed in an image on an I/O interface, and when a user selects a target parking space from the searched parking spaces (S120), an available range for generating a parking path for the selected target parking space is calculated (S130).

The apparatus for controlling parking assistance determines a type of available parking in the available range for generating a parking path calculated in S130 (S140) and makes the parking type-differentiated parking path ranges in an image on an I/O interface (S150).

When a user selects a target parking path range (S160), the apparatus for controlling parking assistance provides parking assistance for the target parking path range (S170).

According to the present disclosure, it is possible to allow a driver to check available-traveling ranges at a glance during parking and to attenuate the driver's anxiety about a collision with neighboring vehicles, by providing parking path ranges for each type of available parking in an image in accordance with the information on available ranges for generating parking path for the position of a target parking position and the length, width, and turning angle of a vehicle during parking.

Further, according to the present disclosure, it is possible to increase convenience for drivers parking, because the drivers can check information on a stop time point and a shifting time point from an image in real time in parking assistance.

As described above, although an apparatus and a method for controlling parking assistance according to the present disclosure were described with reference to the accompanying drawings, the present disclosure is not limited to the exemplary embodiments described herein and the accompanying drawings and may be modified within the protection range of the scope of the present disclosure.

1. An apparatus for providing parking assistance, comprising:
a parking space searching unit that searches parking spaces around a vehicle by analyzing images and sensor-measuring values inputted from a camera and a sensor in the vehicle;
a parking path range calculating unit that calculates available ranges for generating parking paths with respect to traveling directions according to a target parking space selected by a user from the searched parking spaces;
a parking type determining unit that determines types of available parking in the calculated available range for generating parking paths and provides parking path ranges on the basis of parking paths estimated from the types of available parking in an image; and
a parking assistance processing unit that provides parking assistance information for the current position of the vehicle in accordance with a target parking path range for a parking type which is selected by the user from the types of available parking differentiated parking path ranges.

2. The apparatus according to claim 1, wherein the parking path range calculating unit recognizes parking lines around the vehicle and calculates ranges available for generating parking paths on the basis of the recognized parking lines.

3. The apparatus according to claim 1, wherein when no parking line is recognized around the vehicle, the parking path range calculating unit calculates ranges available for generating parking paths on the basis of the sensor-measuring values.

4. The apparatus according to claim 1, wherein the parking assistance processing unit provides information on stop and shifting time points of the vehicle within the target parking path range.

5. The apparatus according to claim 1, wherein the input images are AVM (Around View Monitoring) images.

6. A method of providing parking assistance, comprising:
searching parking spaces around a vehicle by analyzing images and sensor-measuring values inputted from a camera and a sensor in the vehicle;
calculating available ranges for generating parking paths with respect to traveling directions according to a target parking space selected by a user from the searched parking spaces;
determining types of available parking in the calculated available range for generating parking paths and providing parking path ranges on the basis of parking paths estimated from the types of available parking; and
providing parking assistance information for the current position of the vehicle in accordance with a target parking path range for a parking type which is selected by the user from the types of available parking differentiated parking path ranges.

7. The method according to claim 6, wherein the calculating of available ranges for generating parking paths recognizes parking lines around the vehicle and calculates ranges available for generating parking paths on the basis of the recognized parking lines.

8. The method according to claim 6, wherein when no parking line is recognized around the vehicle, the calculating of ranges available for generating parking paths calculates ranges available for generating parking paths on the basis of the sensor-measuring values.

9. The method according to claim 6, wherein the providing parking assistance information provides information on stop and shifting time points of the vehicle within the target parking path range.

10. The method according to claim 6, wherein the input images are AVM (Around View Monitoring) images.
